(19) United States
(12) Patent Application Publication
(10) Pub. No.: US 2026/0127759 A1
(43) Pub. Date: May 7, 2026

(54) Method and Apparatus for Estimating Three-Dimensional Key Points, Computing Device and Medium

(71) Applicants: CHENGDU BOE SMART TECHNOLOGY CO., LTD., Chengdu, Sichuan (CN); BOE TECHNOLOGY GROUP CO., LTD, Beijing (CN)

(72) Inventor: Jie Wang, Beijing (CN)

(73) Assignees: CHENGDU BOE SMART TECHNOLOGY CO., LTD., Chengdu, Sichuan (CN); BOE TECHNOLOGY GROUP CO., LTD, Beijing (CN)

(21) Appl. No.: 18/706,346

(22) PCT Filed: Feb. 24, 2023
(86) PCT No.: PCT/CN2023/078081

§ 371 Date: Apr. 30, 2024

(51) Int. Cl. G06T 7/73

(52) U.S. Cl. CPC G06T 7/74; G06T 2207/30196

(57) ABSTRACT

Provided are a method, an apparatus and a system for estimating three-dimensional key points, a computing device and a medium. The method includes: extracting, from each image associated with a same target scene, two-dimensional key point data of objects included in the image; determining, for each image pair, a matched object pair corresponding to the image pair based on the two-dimensional key point data of each object in a first image and each object in a second image of the image pair, where each matched object pair includes a first object in the first image and a second object in the second image and corresponds to one object in the target scene; and estimating the three-dimensional key point data of each object in the target scene based on the two-dimensional key point data of each first object in the corresponding first image and corresponding second image.

### TECHNICAL FIELD

The present application relates to the technical field of image processing, and particularly to a method and an apparatus for estimating three-dimensional key points of objects in a target scene, a computing device and a medium.

### BACKGROUND

Human body key point detection has been widely applied in human-machine interaction, behavior recognition, and posture analysis. Recognizing key points in images is the basis for a computing device to implement these applications. For example, in the process of the posture analysis, it is necessary to first determine positions of key points of limbs, and then recognize a current posture through a series of algorithms based thereon.

Compared with two-dimensional key points, three-dimensional key points contain more accurate position information of a human body and have a higher practical value. However, general key point detection is aimed at images, that is, the detected key points are all represented by two-dimensional data. Therefore, a simple and accurate way to represent positions of key points with three-dimensional data, namely, a solution to estimate the positions of three-dimensional key points, is needed. In addition, in practical application, the captured image may include a plurality of objects, so that it is also desirable that the solution can perform key point detection on the plurality of objects simultaneously.

It is noted that the information disclosed in the background section is only for enhancement of understanding of the background of the present application and thus it may contain information that does not form the prior art that is already known to a person of ordinary skill in the art.

### SUMMARY

According to an aspect of present application, a method for estimating three-dimensional key point data of objects in a target scene is provided, where one or more objects exist in the target scene. The method comprises: acquiring a plurality of images associated with the target scene, and extracting, from each image of the plurality of images, two-dimensional key point data of objects included in the image, respectively; determining, for an image pair composed of every two images, one or more matched object pairs corresponding to the image pair based on two-dimensional key point data of each object in a first image of the image pair and two-dimensional key point data of each object in a second image of the image pair, wherein each matched object pair comprises a first object in the first image and a second object in the second image and corresponds to one object in the target scene; and estimating three-dimensional key point data of each object in the target scene, based on the two-dimensional key point data of the first object of each matched object pair corresponding to each image pair in a respective first image and the two-dimensional key point data of the second object of the matched object pair in a respective second image.

According to another aspect of present application, a method for estimating three-dimensional key point data of objects in a target scene is provided, where one or more objects exist in the target scene. The method comprises: acquiring a plurality of images associated with the target scene, and extracting, from each image of the plurality of images, two-dimensional key point data of objects included in the image, respectively; based on object recognition, determining one image including a desired object from the plurality of images as a reference image; for each image pair composed of the reference image and each remaining image in the plurality of images, determining whether the image pair corresponds to a matched object pair based on two-dimensional key point data of the desired object in the reference image as a first image of the image pair and two-dimensional key point data of each object in a second image of the image pair, wherein the matched object pair comprises the desired object in the first image and the desired object in the second image; and estimating three-dimensional key point data of the desired object in the target scene based on the two-dimensional key point data of the desired object of each matched object pair determined for each image pair in a respective first image and the two-dimensional key point data of the desired object of the matched object pair in a respective second image.

According to another aspect of present application, a method for estimating three-dimensional key point data of objects in a target scene is provided, where one or more objects exist in the target scene. The apparatus comprises: an acquisition unit configured to acquire a plurality of images associated with the target scene, and extract, from each image of the plurality of images, two-dimensional key point data of the objects included in the image, respectively; a determination unit configured to determine, for an image pair composed of every two images, one or more matched object pairs corresponding to the image pair based on two-dimensional key point data of each object in a first image of the image pair and two-dimensional key point data of each object in a second image of the image pair, wherein each matched object pair comprises a first object in the first image and a second object in the second image and corresponds to one object in the target scene; and an estimation unit configured to estimate three-dimensional key point data of each object in the target scene based on the two-dimensional key point data of the first object of each matched object pair corresponding to each image pair in a respective first image and the two-dimensional key point data of the second object of the matched object pair in a respective second image.

According to another aspect of present application, a method for estimating three-dimensional key point data of objects in a target scene is provided, where one or more objects exist in the target scene. The apparatus comprises: an acquisition unit configured to acquire a plurality of images associated with the target scene, and extract, from each image of the plurality of images, two-dimensional key point data of the objects included in the image, respectively; a determination unit configured to: for each image pair composed of the reference image and each remaining image in the plurality of images, determine whether the image pair corresponds to a matched object pair based on two-dimensional key point data of the desired object in the reference image as a first image of the image pair and two-dimensional key point data of each object in a second image of the image pair, where the matched object pair comprises the desired object in the first image and the desired object in the second image; and a estimation unit configured to estimate three-dimensional key point data of the desired object in the target scene based on the two-dimensional key point data of the desired object of each matched object pair determined for each image pair in a respective first image and the two-dimensional key point data of the desired object of the matched object pair in a respective second image.

According to another aspect of present application, a computing device is provided. The computing device comprises: a processor, and a memory having a computer program stored thereon, which, when executed by the processor, causes the processor to perform the above-mentioned method.

According to another aspect of present application, a computer-readable storage medium is provided. The computer-readable storage medium has a computer program stored thereon, which, when executed by a processor, causes the processor to perform the above-mentioned method.

According to the embodiments of the present application, a plurality of images are obtained by using a plurality of image acquisition devices to synchronously capture an actual target scene, then two-dimensional key point data of individual objects is detected for each image, then object matching between different images captured by different image acquisition devices is performed based on the two-dimensional key point data, and final three-dimensional key point data is obtained based on related two-dimensional key point data for the successfully matched objects. With the adoption of the plurality of image acquisition devices, the plurality of objects in the target scene may be covered such that there is no shielding between the objects, so that the accuracy of estimating the three-dimensional key point data is improved, and the three-dimensional key point data of the plurality of objects in the target scene can be estimated at the same time. In addition, each image acquisition device may adopt a general device, such as a common camera or a video camera, so that there is no need for special design, and the cost is low. In addition, in a case that it is necessary to acquire the three-dimensional key point data of a desired object in the target scene, this method may be further combined with object recognition to estimate the three-dimensional key point data of the desired object.

### BRIEF DESCRIPTION OF THE DRAWINGS

In order to more clearly explain the embodiments of the present application or the technical solution in the prior art, the figures needed in the description of the embodiments of the present application or the prior art will be briefly introduced below. Obviously, the drawings in the following description are only some embodiments recorded in the present application, and other figures may also be derived by those of ordinary skill in the art from these figures of the embodiments of the present application.

FIG. 1A shows a diagram of an exemplary application system for a method for estimating three-dimensional key point data of objects in a target scene provided by an embodiment of the present application.

FIG. 1B shows an exemplary application target scene for a method for estimating three-dimensional key point data of objects in the target scene provided by an embodiment of the present application.

FIG. 2 shows a flow diagram of a method for estimating three-dimensional key point data of objects in a target scene provided by an embodiment of the present application.

FIG. 3 shows more details in step S220 of the method in FIG. 2.

FIG. 4 shows a schematic diagram illustrating principles of a triangulation method.

FIG. 5 shows a schematic diagram of a calibration process of rotation parameters and translation parameters between image acquisition devices.

FIG. 6 shows a structural block diagram of an apparatus for estimating three-dimensional key point data of objects in a target scene according to an embodiment of the present application.

FIG. 7 shows more details of various units of FIG. 6.

FIG. 8 shows a schematic block diagram of a computing device according to an embodiment of the present application.

### DETAILED DESCRIPTION

The technical solutions in the embodiments of the present application will be described below clearly and completely with reference to the drawings in the embodiments of the present application. Obviously, the described embodiments are only some of the embodiments of the present application, but not all of the embodiments. Based on the embodiments in the present application, all other embodiments obtained by those of ordinary skill in the art without involving any inventive effort are within the scope of protection of the present application.

In order to estimate a position of a three-dimensional key point in a target scene, in one solution, a single or monocular camera is used for three-dimensional key point estimation, but the estimated position of the three-dimensional key point in this solution has a large error; in another solution, a binocular camera is used for three-dimensional key point estimation, but objects (for example, multiple human bodies) are prone to shield each other in the image obtained during use, and a Kalman filter is necessarily used to estimate missing key points of one or more objects, and meanwhile, a TOF camera is needed to perform depth measurement, thus leading to a relatively complicated processing process and high cost.

In view of this, the embodiment of the present application provides a solution for estimating three-dimensional key point data of objects based on two-dimensional key point data from a plurality of image acquisition devices (for example, common cameras or video cameras). Since the plurality of image acquisition devices are used at the same time and can capture images of one or more objects existing in a target scene from multiple angles, the images obtained using the plurality of image acquisition devices may include position information (two-dimensional coordinate data) of all objects, that is, it may be considered that the objects will hardly shield each other, and accordingly, the three-dimensional key point data of the objects may be estimated more accurately.

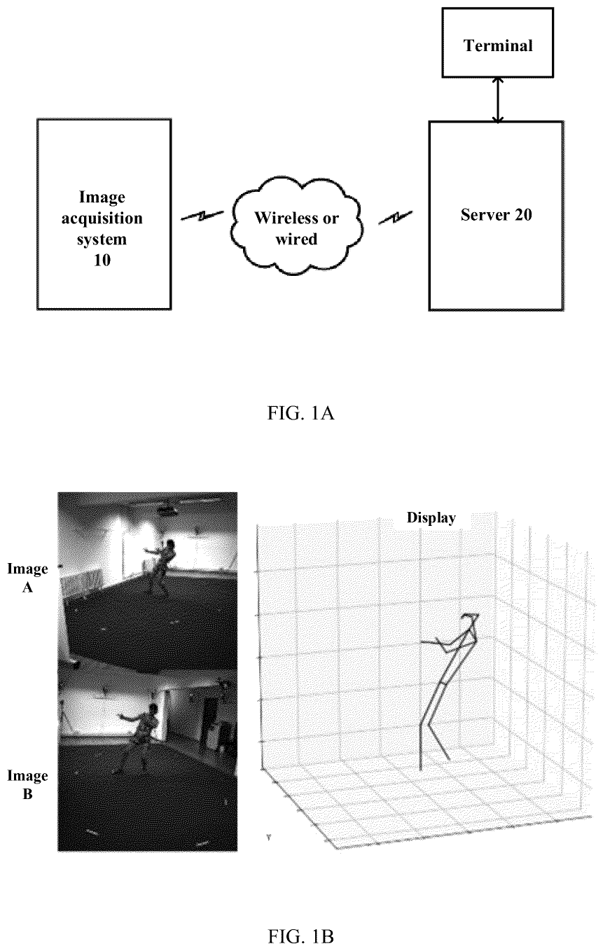

The solution for estimating the three-dimensional key point data of the objects of the present application will be described below in more detail with reference to FIGS. 1A-8.

FIG. 1A shows a diagram of an exemplary application system for a method for estimating three-dimensional key point data of objects in a target scene provided by an embodiment of the present application.

As shown in FIG. 1A, an image acquisition system 10 includes a plurality of image acquisition devices, and the plurality of image acquisition devices are respectively disposed at different positions and angles and transmit, after capturing images of one or more objects, the captured images to a computing device, for example, a server 20. Alternatively, the image acquisition devices transmit captured videos to the computing device, and the computing device obtains a plurality of images from the received videos. After receiving the images, the server 20 performs three-dimensional key point data estimation based on the images by using the method for estimating three-dimensional key point data of objects in the target scene provided by an embodiment of the present application. For example, the server first determines two-dimensional key point data (for example, two-dimensional coordinate data) of the objects in each of the captured images, then estimates three-dimensional key point data based on the two-dimensional key point data, and stores the obtained three-dimensional key point data in a memory, or transmits it back to a local terminal (for example, a computer, a mobile phone, a camera) or a local memory. The server may be a cloud server, a local server, a physical server or a virtual server, which is not limited in the present application.

In addition, the method for estimating three-dimensional key point data of objects in the target scene provided by the embodiment of the present application may also be executed at a terminal, so that the image acquisition system may also transmit the captured images including one or more objects to a local terminal (for example, a computer, a mobile phone and a camera), and the local terminal may execute the method for estimating three-dimensional key point data of objects in the target scene provided by the embodiment of the present application, to store the obtained three-dimensional key point data in a memory. Alternatively, in other embodiments, the method may also be jointly executed by the server and the terminal.

FIG. 1B shows an exemplary application target scene for the method for estimating three-dimensional key point data of objects in the target scene provided by the embodiment of the present application.

As shown in FIG. 1B, two images A and B captured by two image acquisition devices from different positions and angles are shown. The server (such as the server in FIG. 1A) receives the two images A and B, and performs three-dimensional key point data estimation by using the method for estimating the three-dimensional key point data of the objects provided by the embodiment of the present application. For example, the server first determines two-dimensional data (two-dimensional key point data) of respective key points in each of the two images A and B, then estimates three-dimensional key point data based on the two-dimensional key point data of each of the two images, and stores and optionally displays the estimated three-dimensional key point data. For example, as shown in FIG. 1B, the various key points are displayed on a user interface and connected with one another, so that an estimation effect may be visually observed.

FIG. 1B shows an example of estimating three-dimensional key point data of a single person in the target scene used in an application occasion of a single player game. According to the method provided by the embodiment of the present application, three-dimensional key point data of multiple persons in the target scene may also be estimated at the same time.

For example, in an application occasion of a multiplayer game, firstly, the server may acquire a plurality of images captured from different positions and angles (the captured information of people may be more comprehensive and complete by using the plurality of images, so that the shielding between people does not exist as far as possible), and then may estimate, according to the method provided by the embodiment of the present application, the three-dimensional key point data of each person based on the plurality of images, thus laying a foundation for human behavior analysis. For example, three-dimensional key point data at each sampling time point may be determined for each person to determine a posture of each person at each sampling time point, and then an action made by each person may be determined according to the posture of each person at multiple continuous sampling time points, so that a game operation associated with the action may be executed. For another example, in some teaching applications, such as in dance teaching, whether a dance action is standard or not may be judged according to the dance action of each person determined by the processes described above.

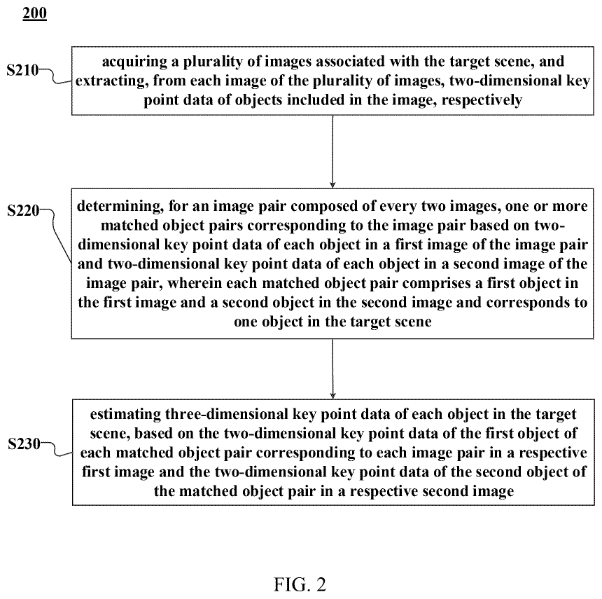

FIG. 2 shows a flow diagram of the method for estimating three-dimensional key point data of objects in a target scene provided by the embodiment of the present application. The method shown in FIG. 2 may be performed by a server or a terminal or a combination thereof. In the present application, there are one or more objects in the target scene, and an image acquisition system (including a plurality of image acquisition devices disposed at different positions) captures images of the target scene.

As shown in FIG. 2, in step S210, a plurality of images associated with a same target scene are acquired, and from each of the plurality of images, two-dimensional key point data of the objects included in a respective image is extracted.

For example, a plurality of images may be acquired from the plurality of image acquisition devices in the image acquisition system. For example, the number of the plurality of image acquisition devices may be, but not limited to, four, and the image acquisition devices are disposed, for example, at four top corners in a space of the target scene.

For example, each of the image acquisition devices may be, for example, a video camera or a camera or the like, and intrinsic parameters of the image acquisition devices are as close as possible, for example, the same model type may be adopted. As an example, the intrinsic parameters of the camera are parameters related to own characteristics of the camera, such as a focal length and a pixel size of the camera.

In addition, the number of objects in the target scene may be one or plural. Since the plurality of image acquisition devices are disposed at different positions and angles, it is possible that only a part of the objects are included in the image captured by each of the image acquisition devices, and the images captured by different image acquisition devices may include different objects. For example, an image captured by a first image acquisition device may include first and second objects, while an image captured by a second image acquisition device may include first, second and third objects, and an image captured by a third image acquisition device may include second and third objects. In the embodiment of the present application, as long as each object in the target scene may be captured by more than two image acquisition devices, the proposed method may be used to estimate the three-dimensional key point data of each object in the target scene.

Optionally, the image acquired from each image acquisition device may be a picture or a video, where in a case of the video, the video is processed to obtain video frames. The plurality of image acquisition devices in the image acquisition system capture images synchronously, so that with regards to key point detection on the video frames, it refers to key point detection on video frames captured by the plurality of image acquisition devices at the same time (or with the same serial number numbered in a time sequence).

In the embodiment of the present application, since the two-dimensional key point data of each object is required to estimate three-dimensional key point data, the selection of the two-dimensional key points needs to be consistent with that of the three-dimensional key points and pre-selected. The selection of key points may be determined according to actual requirements. For example, in a case of an object being a human being, the key points may be eyes, ears, a nose, elbows, knees, etc. Certainly, the objects may also be other material objects, such as robots, animals, etc., and the key points of these material objects may be determined in advance according to their characteristics.

Optionally, a two-dimensional key point detection model may be used to detect key points for a plurality of images captured by the plurality of image acquisition devices of the image acquisition system. For example, the two-dimensional key point detection model may be a hrnet model or an openpose model. For each image, an output result of the two-dimensional key point detection model is two-dimensional key point data in an image coordinate system of a corresponding image acquisition device, with its dimension size being Mᵢ×K×2, where Mᵢ is the number of objects detected in the image (the number of objects detected from images captured by different image acquisition device may be different), K represents the number of key points of each object (for example, 17), 2 represents a two-dimensional coordinate value (x, y) of each key point, and meanwhile, a negative two-dimensional coordinate value can be used to indicate that the corresponding key point have not been detected.

In step S220, for an image pair composed of every two images, one or more matched object pairs corresponding to the image pair are determined based on two-dimensional key point data of each object in a first image of the image pair and two-dimensional key point data of each object in a second image of the image pair, where each matched object pair includes a first object in the first image and a second object in the second image and corresponds to one object in the target scene. For example, each object in the target scene will be captured by at least two image acquisition devices, and the two-dimensional key point data of the object in each image of each image pair may be used to estimate three-dimensional key point data of the object. Since each image may include multiple objects, for each image pair, it is necessary to first determine an object matching relationship between the images of the image pair, that is, the successfully matched objects between the images of the image pair are the same object, within the target scene, captured by different image acquisition devices, and then two pieces of two-dimensional key point data of the successfully matched objects (a matched object pair, corresponding to one object in the target scene) respectively in the two images of the image pair may be used to estimate the corresponding three-dimensional key point data. For example, the image 1 captured by the first image acquisition device includes two objects, and the image 2 captured by the second image acquisition device includes three objects. Therefore, it is necessary to determine the matching relationship between the two objects in the image 1 and the three objects in the image 2. For example, if it is determined that the object A in the image 1 and the object B in the image 2 are the same object (that is, the object A in the image 1 and the object B in the image 2 form one matched object pair, and correspond to one object in the target scene), three-dimensional key point data of the object in the target scene corresponding to the matched object pair may be estimated based on two-dimensional key point data of the object A in the image 1 and two-dimensional key point data of the object B in the image 2.

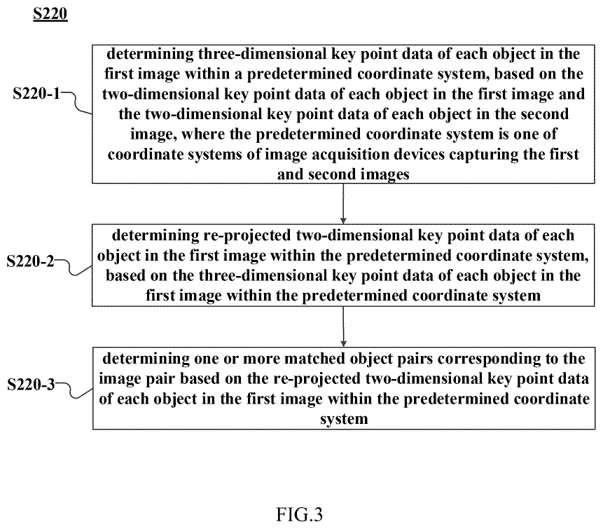

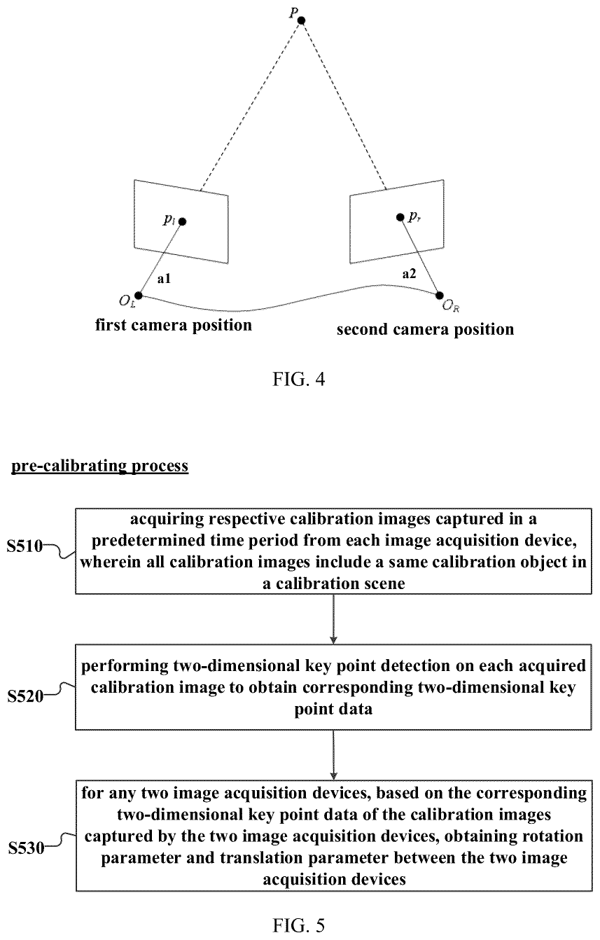

More details on how to determine the matched object pair corresponding to each image pair of the images captured by the image acquisition devices will be described hereinafter with reference to FIGS. 3-4.

In step S230, based on the two-dimensional key point data of the first object of each matched object pair corresponding to each image pair in a respective first image and the two-dimensional key point data of the second object of the matched object pair in a respective second image, three-dimensional key point data of each object in the target scene is estimated.

As mentioned above, objects successfully matched between the images of the image pair is the same object in the target scene captured by different image acquisition devices, so that two pieces of two-dimensional key point data of the successfully matched objects (one object in the target scene corresponding to the matched object pair) respectively in the two images of the image pair may be used to estimate the corresponding three-dimensional key point data.

In addition, each object in the target scene will be captured by at least two image acquisition devices, that is, there may be cases where the object is included in multiple image pairs, so that more than one pieces of three-dimensional key point data may be calculated for the object. In this case, multiple pieces of three-dimensional key point data obtained by estimating each image pair may be averaged, so that final three-dimensional key point data of the object may be determined. For example, an object TA in the target scene is captured by three image acquisition devices (the captured three images are numbered 1/2/3, for example), and two-dimensional key point data of the object TA in each of these three images is known (for example, detected by the two-dimensional key point detection model), so that for each of the three image pairs (image 1-image 2, image 2-image 3, image 1-image 3), the two pieces of two-dimensional key point data of the object may be used to estimate the three-dimensional key point data of the object TA. Therefore, a total of three pieces of three-dimensional key point data of the object TA obtained by performing the estimation for the three image pairs respectively may be averaged, and final three-dimensional key point data of the object may be determined.

As can be seen, in the method for estimating the three-dimensional key point data of objects described with reference to FIG. 2, a plurality of images are obtained by using a plurality of image acquisition devices to synchronously capture an actual target scene, then two-dimensional key point data of individual objects is detected for each image, then object matching between different images captured by different image acquisition devices is performed based on the two-dimensional key point data, and final three-dimensional key point data is obtained based on related two-dimensional key point data for the successfully matched objects. According to the method, with the adoption of the plurality of image acquisition devices, the plurality of objects in the target scene may be covered such that there is no shielding between the objects, so that the accuracy of estimating the three-dimensional key point data is improved, and the three-dimensional key point data of the plurality of objects can be estimated at the same time. In addition, the image acquisition device may adopt a general device, such as a common camera or a video camera, so that there is no need for special design, and the cost is low.

FIG. 3 shows more details in step S220 of the method in FIG. 2.

As shown in FIG. 3, the step of determining the matched object pairs corresponding to each image pair may include the following sub-steps. The following sub-steps are performed on the image pair captured by every two image acquisition devices. For example, each image pair includes a first image and a second image.

In sub-step S220-1, three-dimensional key point data of each object in the first image within a predetermined coordinate system is determined based on two-dimensional key point data of each object in the first image and two-dimensional key point data of each object in the second image.

For example, the predetermined coordinate system may be a coordinate system of the image acquisition device (the first image acquisition device) that captures the first image, or may be a coordinate system of the image acquisition device (the second image acquisition device) that captures the second image or a coordinate system of other image acquisition devices due to the fact that the coordinate systems of different image acquisition devices may be transformed mutually. In addition, the two-dimensional key point data of each object in the first image (based on the coordinate system of the first image acquisition device) and the two-dimensional key point data of each object in the second image (based on the coordinate system of the second image acquisition device) may also be transformed into the coordinate system of any desired image acquisition device through coordinate transformation.

For example, in a case that the predetermined coordinate system is the coordinate system of the second image acquisition device, the three-dimensional key point data of each object in the first image within the coordinate system of one of the plurality of image acquisition devices (for example, the coordinate system of the first image acquisition device) may be determined using a triangulation method and based on the two-dimensional key point data of each object in the first image and the two-dimensional key point data of each object in the second image; and coordinate transformation is performed on the three-dimensional key point data of each object in the first image within the coordinate system of the one of the plurality of image acquisition devices (for example, the coordinate system of the first image acquisition device), to obtain three-dimensional key point data of each object in the first image within the predetermined coordinate system.

For example, images (represented by the first image and the second image) captured by an i-th image acquisition device and a j-th image acquisition device form one image pair, and the two-dimensional key point data of the objects in the first image and the second image included in the image pair are triangulated. For example, two-dimensional key point data of a k-th object in the first image and an l-th object in the second image are triangulated (a triangulation result is based on the coordinate system of the i-th image acquisition device). Since the object matching relationship between the first image and the second image cannot be determined at this time, any two objects between the first image and the second image need to be triangulated, that is, any two objects are assumed to be one matched object pair (not real matched object pair) in turn, and three-dimensional key point data (which will be used to determine the accurate three-dimensional key point data in subsequent processes) of the object corresponding to the matched object pair within the predetermined coordinate system is calculated by triangulation. For example, it is assumed that the first image includes 4 objects and the second image includes 5 objects, 4×5=20 triangulations are required. For example, a value of each measurement result in the coordinate system of the i-th image acquisition device is Pᵢₖⱼₗ, with its dimension size being K×3, where K is the number of key points of the object (such as 17), and 3 represents (x, y, z) coordinate values (three-dimensional).

Optionally, for any two image acquisition devices i and j, the value (/Pᵢₖⱼₗ) of the measurement result in the coordinate system of the j-th image acquisition device may be based on the value (Pᵢₖⱼₗ) of the measurement result in the coordinate system of the i-th image acquisition device, and is obtained by the following equation:

$$/ {P}_{ikjl} = {R}_{i j} {P}_{ikjl} + {t}_{ij} ,$$

where, Rᵢⱼ and tᵢⱼ are the calibrated rotation parameter and translation parameter (i.e., calibration parameters) from the image acquisition device i to the image acquisition device j.

Therefore, if the predetermined coordinate system is the coordinate system of the i-th image acquisition device, coordinate transformation may not be performed, or the rotation parameter and translation parameter may be set to 1 and 0 respectively; if the predetermined coordinate system is the coordinate system of the j-th capturing device, the calibration parameters may be used to perform transformation between the coordinate systems.

Optionally, in the present application, the coordinate system of the j-th image acquisition device is taken as an example of the predetermined coordinate system, this is because in this case the triangulation-based measurement result is further subjected to coordinate transformation, and accordingly an error between an estimated value and an actual value can be highlighted better, to facilitate subsequent determination of the matched object pair.

FIG. 4 shows a schematic diagram illustrating principles of a triangulation method.

As shown in FIG. 4, taking the image acquisition device as a camera as an example, O_{L} is a position of a first camera and O_{R} is a position of a second camera, and based on camera extrinsic parameters between the second camera and the first camera, a position relationship between O_{L} and O_{R} may be obtained. For a physical point P in a three-dimensional space, an imaging position in an image plane of the first camera is pₗ (two-dimensional coordinate data), and an imaging position in an image plane of the second camera is pᵣ (two-dimensional coordinate data). For example, if it is assumed that the k-th object in the first image and the l-th object in the second image are the same object as mentioned above, in combination with FIG. 4, it is assumed that an imaging position of a certain key point of this object is pₗ in the first image and pᵣ in the second image, so that the coordinate of the key point in the three-dimensional space (that is, the three-dimensional coordinate of a key point pair in a camera coordinate system) may be determined through the following processes. O_{L}, O_{R}, pₗ and pᵣ are transformed into the same coordinate system; for O_{L}, O_{R}, pₗ and pᵣ in the same coordinate system, there is a straight line a1 between O_{L}, and pₗ, and there is a straight line a2 between O_{R} and pᵣ; if there is an intersection point between the straight line a1 and the straight line a2, the intersection point of the straight line a1 and the straight line a2 is a physical point P; if there is no intersection point between the straight line a1 and the straight line a2, the physical point P is a closest point to the straight line a1 and the straight line a2 (a sum of a vertical distance to the straight line a1 and a vertical distance to the straight line a2 is minimum). Based on the above application target scene, three-dimensional space coordinates of the physical point P may be obtained by the triangulation method, and the three-dimensional space coordinates of the physical point P may be three-dimensional coordinates of a certain key point of the object.

In addition, in some embodiments, for the convenience of calculation, both the two-dimensional coordinate and the three-dimensional coordinate are in the format of the homogeneous coordinate, where the homogeneous coordinate uses a (n+1)-dimensional vector to represent a n-dimensional vector, and when n is 2, the two-dimensional coordinate is transformed into a three-dimensional coordinate. For example, when the coordinate of the imaging position pₗ of the image plane of the first camera is [ul, vl], the coordinate may be transformed into the homogeneous coordinate [ul, vl, w], where w may be any value which is not limited herein, for example, when w is 1, the homogeneous coordinate is [ul, vl, 1].

In this way, the measurement result obtained by triangulation is also expressed by the homogeneous coordinate, that is, when any two objects between two images in an image pair are assumed to be the same object in the target scene, three-dimensional key point data of this object in the predetermined coordinate system is also in the format of homogeneous coordinate, for example, [x, y, z, w].

Then, in sub-step S220-2, re-projected two-dimensional key point data of each object in the first image within the predetermined coordinate system is determined based on the three-dimensional key point data of each object in the first image within the predetermined coordinate system.

For example, three-dimensional key point data corresponding to each object in the first image in the format of homogeneous coordinate may be transformed into two-dimensional key point data in the format of non-homogeneous coordinate, that is, re-projection is performed, the process of which is shown as follows (taking the coordinate system of the j-th image acquisition device as a predetermined coordinate system as an example):

$$/ {P}_{ikjl}^{2 d} = \frac{/ {P}_{i k j l} [ … , : 2 ]}{/ {P}_{i k j l} [ … , 2 ]}$$

where,

$$/ {P}_{ikjl}^{2 d}$$

represents re-projected two-dimensional key point data of each object in the first image within the predetermined coordinate system, the dimension is K×2, K is the number of key points of each object (such as 17), /Pᵢₖⱼₗ [ . . . ,: 2] represents first two items of coordinate data (for example, x and y coordinate values) among the coordinate data indicated by the three-dimensional key point data of each object in the first image within the predetermined coordinate system, and /Pᵢₖⱼₗ [ . . . , 2] represents the last item of coordinate data (for example, w coordinate value) among the coordinate data indicated by the three-dimensional key point data of each object in the first image within the predetermined coordinate system. The two-dimensional key point data and three-dimensional key point data of each object described herein may be regarded as two-dimensional coordinate data or three-dimensional coordinate data of each key point of the object.

In sub-step S220-3, based on re-projected two-dimensional key point data of each object in the first image within the predetermined coordinate system, one or more matched object pairs corresponding to the image pair are determined.

Optionally, based on the re-projected two-dimensional data of each object in the first image within the predetermined coordinate system, an error between the re-projected two-dimensional key point data of each object in the first image within the predetermined coordinate system and the two-dimensional key point data of each object in the second image within the predetermined coordinate system may be determined as a re-projection error; then, one or more matched object pairs corresponding to the image pair may be determined based on the re-projection error.

For example, for each object in the first image, an error between the re-projected two-dimensional key point data of the object and two-dimensional key point data of each of objects in the second image within the predetermined coordinate system may be calculated as a re-projection error.

For example, the above re-projection error may be calculated by the following equation:

$$D ( k , l ) = \frac{{\sum }_{e} d ( {p}_{ke} , {p}_{l e} ) δ ( {v}_{ke} , {v}_{l e} )}{size {\sum }_{e} δ ( {v}_{k e} , {v}_{l e} )}$$

where, k represents a k-th object in a first image of any image pair; l represents an l-th object in a second image of this image pair; size represents a magnitude of dimension (as an example, specifically, an average value of a diagonal length of a key point three-dimensional bounding box of the k-th object in the first image and a diagonal length of a key point three-dimensional bounding box of the l-th object in the second image may be used); δ(νₖₑ, νₗₑ) indicates that if the e-th key point of the k-th object and the e-th key point of the l-th object are available, it is 1, or otherwise, 0; whether the e-th key points of the two objects are available is determined by an output result of the two-dimensional key point detection model mentioned above (usually, a threshold, such as 0.5 is set, if a detected confidence of a key point is greater than a corresponding threshold, it indicates that the key point is available, and if the detected confidence thereof is less than the corresponding threshold, it indicates that the key point is unavailable); d(pₖₑ, pₗₑ) represents an Euclidean distance between the e-th key point of the k-th object in the first image and the e-th key point of the l-th object in the second image. It is to be noted that through the above re-projection process, all the objects in the first image and all the objects in the second image are subjected to a mutual object matching process between images and re-projected into the predetermined coordinate system. The so-called mutual object matching process between images means that the reprojection is performed with respect to the predetermined coordinate system (here, the coordinate system of the j-th image acquisition device is taken as an example) assuming that two objects correspond to the same object in the target scene, regardless of whether the two objects are actually matched or not, so as to obtain the re-projected two-dimensional key point data, and then the re-projected two-dimensional key point data and real two-dimensional key point data are subjected to error calculation (with respect to a sum of Euclidean distances for the two-dimensional key point coordinate data of all key points), thereby obtaining the error between the re-projected two-dimensional key point data of each object (k) in the first image and the two-dimensional key point data of each object (1) in the second image.

In order to facilitate the subsequent calculation, these errors may be expressed by an error matrix, and thus the dimension of the error matrix is Mᵢ×Mⱼ, where, Mᵢ and Mⱼ are the number of objects in the first image and the number of objects in the second image respectively. For example, there are 3 objects in the first image and 100 objects in the second image, and the number of calculated errors (Euclidean distance) is 3×100, that is, the dimension of the error matrix is 3×100.

Then, an optimal matching relationship of the various objects detected in the first image and the second image may be calculated according to the above calculated errors (for example, according to the above error matrix). For example, for each object in the first image, an object in the second image which has a minimum error relative to the object in the first image may be determined, or the object in the second image with a too large error (corresponding the Euclidean distance) relative to the object in the first image may be removed (for example, two objects with the Euclidean distance exceeding the distance threshold of 0.3 are determined as being mismatched), and a one-to-one matched object pair may be obtained, so that the object matching relationship between the two images is obtained after the processing in this step. Optionally, this process may be implemented for the error matrix using a Hungarian algorithm, for example. The Hungarian algorithm is a common algorithm in the art, so that the description of its specific process is omitted here to avoid obscuring the content of the present application. Certainly, other algorithms may also be employed to determine the optimal matching relationship between the objects in two images in view of these errors.

For example, there are 3 objects in the first image and 100 objects in the second image. The obtained result may be that the objects numbered 0, 1 and 2 in the first image are matched with the objects numbered 3, 9 and 87 in the second image respectively and other objects in the second image fail to match, or there are no objects in the first image that may be matched with the objects in the second image (the error (Euclidean distance) is greater than the distance threshold). However, it is to be understood that other objects in the second image may be matched with objects in another image captured by the other image acquisition devices, in which case the second image and the other image form another image pair, and the object matching relationship between the images is determined similarly to the above process.

To sum up, for each image pair, the object matching relationship between the first image and the second image may be determined by determining the respective errors between re-projected two-dimensional key point data of each object in the first image and two-dimensional key point data of each object in the second image, that is, each of objects in the first image is the same as which one of objects in the second image or constitutes a matched object pair with which one object in the second image.

By performing the above operations for each image pair, the object matching relationship between the two images of each image pair may be obtained. More details on estimating the three-dimensional key point data of each object in the target scene based on these matched object pairs in step S230 are described below.

For each image pair, if one or more matched object pairs corresponding to each image pair are obtained, the three-dimensional key point data of the object in the target scene corresponding to each matched object pair in the image pair within the target coordinate system may be calculated by using a triangulation algorithm.

For example, if the object A in the first image and the object B in the second image are matched and correspond to a real object TA in the target scene, then, according to the two-dimensional key point data of the object A in the first image and the two-dimensional key point data of the object B in the second image, and by taking the coordinate system of the image acquisition device that captures the first image as a target coordinate system corresponding to the image pair, three-dimensional key point data of the real object TA (corresponding to the object A in the first image or the object B in the second image) in the target scene within the target coordinate system may be calculated. Optionally, for each image pair, the target coordinate system corresponding to the image pair may also be a coordinate system of any one of the plurality of image acquisition devices, and may be the same as or different from the predetermined coordinate system corresponding to the image pair mentioned above.

In addition, since the respective coordinate systems of the image acquisition devices that capture each image are different, it is necessary to transform the solved three-dimensional key point data within the target coordinate system corresponding to each image pair into a reference coordinate system. For example, if the reference coordinate system is the coordinate system of the image acquisition device numbered 0 (certainly, the coordinate system of any other image acquisition device may also be used as the reference coordinate system), then the three-dimensional key point data Pᵢₖⱼ calculated with the coordinate system of any image acquisition device i as the target coordinate system may be transformed into the coordinate system of the image acquisition device numbered 0, which may be shown in the following equation:

$${P}_{i k j}^{0} = {R}_{i 0} {P}_{i k j} + {t}_{i 0}$$

where, Pᵢₖⱼ represents three-dimensional key point data of the k-th object within the coordinate system of the image acquisition device i obtained based on the k-th object in the first image captured by the image acquisition device i and the l-th object in the second image captured by the image acquisition device j (the first image and the second image are matched), and Rᵢ₀ and tᵢ₀ are the calibrated rotation parameter and translation parameter from the image acquisition device i to the image acquisition device 0. In this way, the three-dimensional key point data of all objects may be transformed from the target coordinate system to the reference coordinate system.

In addition, as mentioned above, each object in the target scene will be captured by at least two image acquisition devices, and one piece of three-dimensional key point data may be calculated for each image pair including the object, so that it is possible to calculate multiple pieces of three-dimensional key point data for the object.

That is to say, in some cases, at least two of image pairs composed of the plurality of images acquired from the image acquisition system each include at least one object in the target scene, then for each of the at least one object, three-dimensional key point data of the object within the reference coordinate system are determined for each of the at least two image pairs respectively (using the method as described in FIG. 2 above), at least two pieces of three-dimensional key point data corresponding to the at least two image pairs in a one-to-one manner are obtained, and then based on the at least two pieces of three-dimensional key point data, final three-dimensional key point data of the object within the reference coordinate system is estimated. For example, the at least two pieces of three-dimensional key point data may be averaged, so that the final three-dimensional key point data of the object may be determined.

For example, the object TA in the target scene is captured by three image acquisition devices (the captured three images are numbered 1/2/3, for example), and two-dimensional key point data of the object TA in each of the three images may be determined after matching, so that the two-dimensional key point data of the object in the three image pairs (1-2,2-3,1-3) may be used to estimate the three-dimensional key point data of the object within the reference coordinate system respectively. Therefore, a total of three pieces of three-dimensional key point data obtained by respectively performing estimation on the three image pairs including the object TA may be averaged to determine final three-dimensional key point data of the object TA. For example,

$${P}_{k}^{0} = \frac{{\sum }_{i} {\sum }_{j} {P}_{i k j}}{N R}$$

where, Pᵢₖⱼ represents three-dimensional key point data in the coordinate system of the image acquisition device i based on the k-th object in the first image captured by the image acquisition device i and the l-th object (corresponding to the object TA in the target scene) in the second image captured by the image acquisition device j; NR represents the number of pieces of three-dimensional key point data actually involved in the calculation. The calculation times can be appropriately reduced according to the accuracy requirements in an actual use process. For instance, only the image acquisition device as the reference is used and combined with the other image acquisition device. For example, even if the image acquisition devices 0/2/8 each capture the object TA in the target scene, the three-dimensional key point data of the object TA within the reference coordinate system may be determined only based on the image pair captured by the image acquisition devices 0 and 2.

Optionally, since the final three-dimensional key point data of each object is a data collection of coordinate values of multiple key points of the object, while some three-dimensional key points may not be actually detected and there may be duplicate key points in the detected multiple key points, deduplication processing may be performed.

Therefore, the method for estimating the three-dimensional key points further includes: determining whether any two key points of each object are duplicate key points based on the final three-dimensional key point data of the object; and in a case that it is determined that there are duplicate key points, performing deduplication processing.

For example, an error (e.g., the Euclidean distance) between coordinate values of any two key points of each object is calculated based on the final three-dimensional key point data of the object; and when the error is less than an error threshold, it is determined that there are duplicate key points and deduplication processing is performed, for example, one of the duplicate key points is selected as the estimated final three-dimensional key point.

According to the method for estimating the three-dimensional key point data of the objects described above, based on the plurality of images captured by the plurality of image acquisition devices, as long as any object in the target scene appears in the field of view of two (possibly more) of the image acquisition devices (the two-dimensional key point data of the object in each image may be obtained correspondingly), the three-dimensional key point data of the object within the reference coordinate system may be estimated, so that compared with other methods for estimating the three-dimensional key point data, the shielding between the objects has less influence on an estimation result. In addition, when one target object appears in the field of view of more than two image acquisition devices, for these images, observation results of multiple image acquisition devices may be simultaneously fused to estimate the final three-dimensional key point data. For example, if the images of n image acquisition devices are used to estimate the three-dimensional key point data, its variance will be reduced to 1/n correspondingly, and its accuracy will be correspondingly higher.

Through the method for estimating the three-dimensional key point data of the objects described above with reference to FIGS. 2-5, the three-dimensional key point data of all objects in the target scene may be obtained at the same time, so that in a case that the three-dimensional key point data of only part of objects (desired objects) is needed, after the three-dimensional key point data of all objects is obtained, an additional selection process can be added to obtain three-dimensional key point data of these desired objects.

In addition, according to other implementations, the method described above may be combined with object recognition technology to estimate the three-dimensional key point data of the desired objects.

For example, all images including (one or more in total) desired objects may be recognized by the object recognition technology, and then three-dimensional key point data of each desired object may be estimated according to the two-dimensional key point data of the desired object in different images.

For another example, since the computation amount of the object recognition process is greater than that of the above process of determining the matching relationship based on calculating the re-projection error, one image may be recognized for each desired object by the object recognition technology first, then whether the desired object is included in other images may be determined based on the process of determining the matched object pair described above, and accordingly the three-dimensional key point data of the desired object is estimated according to the two-dimensional key point data of the desired object in different images.

Specifically, a method for estimating three-dimensional key point data of objects according to another embodiment may include the following steps.

Firstly, a plurality of images associated with a same target scene are acquired, and for each image of the plurality of images, two-dimensional key point data of the objects included in the image is extracted.

This process is similar to step S210 described with reference to FIG. 2.

Then, based on object recognition, one image including a desired object is determined from the plurality of images as a reference image.

For example, the desired object may be, for example, a child, an adult or an animal, etc.

Optionally, the object recognition technology may be implemented based on neural network, such as a deep learning model based on a convolutional neural network, etc.

Optionally, each image may include a plurality of desired objects, then this step and subsequent steps may be performed for each desired object.

Next, for each image pair composed of the reference image and each remaining image in the plurality of images, it is determined whether the image pair corresponds to a matched object pair based on the two-dimensional key point data of the desired object in the reference image as a first image of the image pair and the two-dimensional key point data of each object in a second image of the image pair, where the matched object pair includes the desired object in the first image and the desired object in the second image.

For example, the desired object may be not included in some images, so that the image pairs formed by these images and the reference image do not include the matched object pair. For example, the matching relationship may be determined with reference to the method described above, and the calculated re-projection error might be too large (greater than the threshold), so that it may be determined that these image pairs do not include the matched object pair.

Finally, the three-dimensional key point data of the desired object in the target scene is estimated based on the two-dimensional key point data of the desired object of each matched object pair determined for each image pair in a respective first image and the two-dimensional key point data of the desired object of the matched object pair in a respective second image.

For example, similarly, one piece of three-dimensional key point data may be estimated based on each pair of two-dimensional key point data for the desired object using triangulation, and all three-dimensional key point data may be averaged to obtain the final three-dimensional key point data for the desired object.

More details on the above steps of determining the matched object pair in the image pair and estimating the three-dimensional key point data of the desired object in this method are similar to the processes described above, so that the detailed description thereof is omitted here.

In the method for estimating the three-dimensional key point data of the objects as mentioned above, parameter transformation between image acquisition devices or transformation between coordinate systems of the image acquisition devices is involved, which transformation is implemented based on the rotation parameter and the translation parameter between the image acquisition devices. Therefore, the method may further include the following steps: pre-calibrating rotation parameter and translation parameter between image acquisition devices such that coordinate systems of the plurality of image acquisition devices may be subjected to coordinate transformation and thus can be used to estimate three-dimensional key point data of the objects.

The process of calibrating the rotation parameter and the translation parameter between the image acquisition devices will be described below with reference to FIG. 5. As mentioned above, all image acquisition devices use the same model type, and their intrinsic parameters are as close as possible.

For example, as shown in FIG. 5, in step S510, calibration images captured in a predetermined time period are acquired from each image acquisition device, wherein all calibration images include a same calibration object in a calibration scene.

For example, the calibration object walks in the calibration scene, and each image acquisition device synchronously captures a video of about 30 seconds, so that a plurality of video frame images may be obtained from the video.

Then, in step S520, two-dimensional key point detection is performed on each acquired calibration image to obtain corresponding two-dimensional key point data.

The result of two-dimensional key point detection for each calibration image is two-dimensional key point data of each key point of the calibration object in the two-dimensional coordinate system of the calibration image, and a data collection PD is obtained, with the dimension of the data collection PD being N×L×K×2, where N represents the number of image acquisition devices, L represents the number of frames captured (for example, 30 seconds of data, 30 frames per second, then L=900), K represents the number of key points of the calibration object (as mentioned above, the key points are pre-selected, for example, 17 key points), 2 represents the corresponding x and y coordinate values of each key point, and negative x and y coordinate values may be used to indicate that the corresponding key points has not been detected.

Next, in step S530, for any two image acquisition devices, based on the corresponding two-dimensional key point data (P[i] and P[j] (both dimensions are L×K×2)) of the calibration images captured by the two image acquisition devices, the rotation parameter and translation parameter between the two image acquisition devices are obtained.

For example, an eigenmatrix Eᵢⱼ may be calculated using a fitting algorithm, for example, a random sample consensus algorithm (RANSAC algorithm), to obtain the rotation parameter Rᵢⱼ and translation parameter tᵢⱼ from the image acquisition device i to the image acquisition device j. The RANSAC algorithm is an iterative method to estimate a mathematical model from an observation data set containing outliers. For example, when calculating the rotation parameter and translation parameter from the image acquisition device i to the image acquisition device j, the observation data set is corresponding two-dimensional key point data of a plurality of calibration images captured by the image acquisition device i in a predetermined time period and corresponding two-dimensional key point data of a plurality of calibration images captured by the image acquisition device j in the predetermined time period. The specific process of the RANSAC algorithm is well known in the art, so that the description of its specific process is omitted here.

It should be noted that there are rotation parameter and translation parameter between any two image acquisition devices. For example, three pairs of rotation parameter and translation parameter are included for three image acquisition devices and six pairs of rotation parameter and translation parameter are included for four image acquisition devices.

After the process of parameter calibration is completed, the parameter transformation between every two image acquisition devices or the transformation between the coordinate systems of the image acquisition devices may be completed based on the pre-calibrated rotation parameters and translation parameters.

According to another aspect of the present application, there is also provided an apparatus for estimating three-dimensional key point data of target objects.

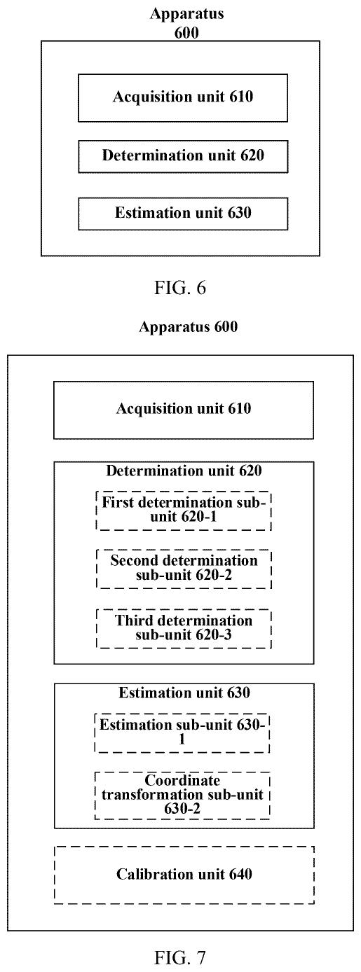

FIG. 6 shows a structural block diagram of an apparatus for estimating three-dimensional key point data of a target object according to an embodiment of the present application. The apparatus may be a server or a terminal.

As shown in FIG. 6, an apparatus 600 may include an acquisition unit 610, a determination unit 620 and an estimation unit 630.

The acquisition unit 610 may be configured to acquire a plurality of images associated with a same target scene, and extract, from each of the plurality of images, two-dimensional key point data of the objects included in a respective image, respectively.

For example, the acquisition unit 610 may perform two-dimensional key point detection on each of the plurality of images using a two-dimensional key point detection model, to obtain two-dimensional key point data of the objects included in the respective image.

The determination unit 620 may be configured to determine, for an image pair composed of every two images, one or more matched object pairs corresponding to the image pair based on two-dimensional key point data of each object in a first image of the image pair and two-dimensional key point data of each object in a second image of the image pair, where each matched object pair includes a first object in the first image and a second object in the second image and corresponds to one object in the target scene.

The estimation unit 630 may be configured to estimate, based on the two-dimensional key point data of the first object of each matched object pair corresponding to each image pair in a respective first image and the two-dimensional key point data of the second object of the matched object pair in a respective second image, three-dimensional key point data of each object in the target scene.

FIG. 7 shows more details of various units of FIG. 6.

For example, as shown in FIG. 7, the determination unit 620 may further include a first determination sub-unit 620-1, a second determination sub-unit 620-2 and a third determination sub-unit 620-3.

The first determination sub-unit 620-1 may be configured to determine, for each image pair, three-dimensional key point data of each object in the first image of the image pair within a predetermined coordinate system based on two-dimensional key point data of each object in the first image and two-dimensional key point data of each object in the second image of the image pair.

For example, the first determination sub-unit 620-1 may be specifically configured to: determine, for each image pair, three-dimensional key point data of each object in the first image of the image pair within the coordinate system of one of a plurality of image acquisition devices (for example, the first image acquisition device) by the triangulation method and based on two-dimensional key point data of each object in the first image of the image pair and two-dimensional key point data of each object in the second image; perform coordinate transformation on the three-dimensional key point data of each object in the first image of the image pair within the coordinate system of one of the plurality of image acquisition devices, to obtain three-dimensional key point data of each object in the first image of the image pair within the predetermined coordinate system.

The second determination sub-unit 620-2 may be configured to determine, for each image pair, re-projected two-dimensional key point data of each object in the first image of the image pair within the predetermined coordinate system based on the three-dimensional key point data of each object in the first image of the image pair within the predetermined coordinate system.

For example, the three-dimensional key point data of each object within the predetermined coordinate system is homogeneous three-dimensional coordinate data, and the second determination sub-unit 620-2 may be specifically configured to: for each image pair, transform three-dimensional key point data of each object in the first image of the image pair within the predetermined coordinate system into nonhomogeneous three-dimensional coordinate data, to obtain re-projected two-dimensional key point data of each object in the first image of the image pair within the predetermined coordinate system.

The third determination sub-unit 620-3 may be configured to determine, for each image pair, one or more matched object pairs corresponding to the image pair based on the re-projected two-dimensional key point data of each object in the first image of the image pair within the predetermined coordinate system.

For example, the third determination sub-unit 620-3 may be specifically configured to: based on the re-projected two-dimensional key point data of each object in the first image of the image pair within the predetermined coordinate system, determine an error between re-projected two-dimensional key point data of each object in the first image of the image pair within the predetermined coordinate system and two-dimensional key point data of each object in the second image of the image pair within the predetermined coordinate system, as a re-projection error; and determine one or more matched object pairs corresponding to the image pair based on the re-projection error.

As shown in FIG. 7, the estimation unit 630 may include an estimation sub-unit 630-1 and a coordinate transformation sub-unit 630-2.

The estimation sub-unit 630-1 may be configured to estimate, using a triangulation method and based on the two-dimensional key point data of the first object of each matched object pair corresponding to each image pair in a respective first image and the two-dimensional key point data of the second object of the matched object pair in a respective second image, three-dimensional key point data of the object in the target scene corresponding to each matched object pair within the target coordinate system.

The coordinate transformation sub-unit 630-2 may be configured to transform the three-dimensional key point data of the object in the target scene corresponding to each matched object pair within the target coordinate system into a reference coordinate system, to obtain three-dimensional key point data of the object in the target scene corresponding to each matched object pair within the reference coordinate system.

Optionally, at least two image pairs of the plurality of image pairs formed by the plurality of images each include at least one object in the target scene. At this time, the estimation sub-unit may be further configured to determine, for each of the at least one object, the three-dimensional key point data of the object within the reference coordinate system for each image pair in the at least two image pairs, to obtain at least two pieces of three-dimensional key point data corresponding to the at least two image pairs in a one-to-one manner; and estimate final three-dimensional key point data of the object within the reference coordinate system based on the at least two pieces of three-dimensional key point data.

Optionally, the final three-dimensional key point data of each object is a data collection of coordinate values of a plurality of key points of the object, and the determination unit may further include a fourth determination sub-unit, which is configured to determine whether any two key points of each object are duplicate key points based on the final three-dimensional key point data of the object, and perform deduplication processing in a case that it is determined that there are duplicate key points.

Optionally, the apparatus 600 may further include a calibrating unit 640, which is configured to pre-calibrate rotation parameter and translation parameter between the plurality of plurality of image acquisition devices that capture the plurality of images, so that coordinate transformation may be performed between corresponding coordinate systems of the plurality of image acquisition devices.

Further details of operations of the various units described above may be found with reference to FIGS. 2-5 and will be omitted here.

In addition, if the estimation of the three-dimensional key point data is implemented in combination with the object recognition process, the apparatus 600 may further include an object recognition unit which is configured to determine one image including a desired object from the plurality of images as a reference image, based on the object recognition. In this way, the determination unit 620 is alternatively configured to: for each image pair composed of the reference image and each remaining image in the plurality of images, determine whether the image pair corresponds to a matched object pair based on two-dimensional key point data of the desired object in the reference image as a first image of the image pair and two-dimensional key point data of each object in a second image of the image pair, where the matched object pair comprises the desired object in the first image and the desired object in the second image; and the estimation unit 630 is alternatively configured to estimate three-dimensional key point data of the desired object in the target scene based on the two-dimensional key point data of the desired object of each matched object pair determined for each image pair in a respective first image and the two-dimensional key point data of the desired object of the matched object pair in a respective second image.

In addition, although the above units and sub-units are shown by way of example in FIGS. 6-7, it is to be understood that the apparatus 600 may be divided into more or less units according to different functions, or each unit may be divided into further more or less sub-units. In some exemplary implementations, a unit or its sub-units may be implemented by electronic hardware (e.g., a general-purpose processor, DSP, ASIC, FPGA or other programmable logic device, a discrete gate or a transistor logic, a discrete hardware component, etc.), computer software (for example, which may be stored in a random access memory (RAM), a flash memory, a read-only memory (ROM), an erasable programmable ROM (EPROM), etc.) or a combination of both.

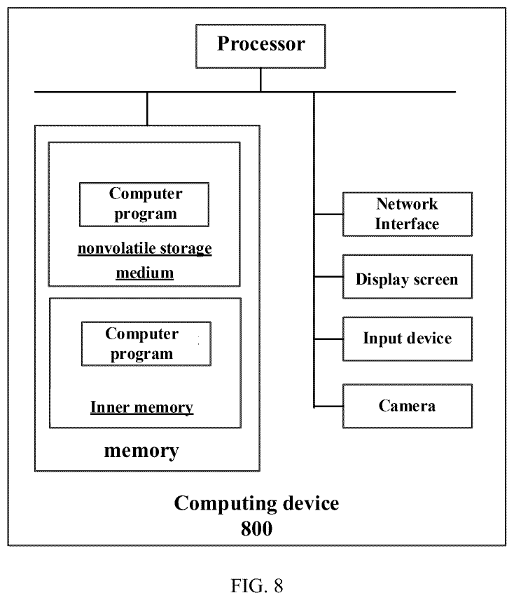

FIG. 8 shows a schematic block diagram of a computing device according to an embodiment of the present application. The computing device may be the computing device (a server 20 or a terminal) as shown in FIG. 1.

As shown in FIG. 8, the computing device 800 includes one or more processors, one or more memories, a network interface, an input apparatus and a display screen that are connected by system buses. The memory includes a nonvolatile storage medium and an internal memory. The nonvolatile storage medium of the computing device stores an operating system, and may also store a computer executable program which, when executed by a processor, may cause the processor to implement various operations of the method for estimating the three-dimensional key point data of objects in the target scene as described above. The internal memory may also have stored therein a computer executable program which, when executed by the processor, may cause the processor to perform various operations described in the steps of the method for estimating the three-dimensional key point data of objects in the target scene.

The processor may be an integrated circuit chip with signal processing capability. The processor above may be a general-purpose processor, a digital signal processor (DSP), an application-specific integrated circuit (ASIC), a field programmable gate array (FPGA) or other programmable logic device, a discrete gate or transistor logic device, and a discrete hardware component, through which the methods, steps and logic block diagrams disclosed in the embodiments of the present application may be implemented or executed. The general-purpose processor may be a microprocessor or any conventional processor, and it may be an X84 architecture or an ARM architecture.

The nonvolatile memory may be a read-only memory (ROM), a programmable read-only memory (PROM), an erasable programmable read-only memory (EPROM), an electrically erasable programmable read-only memory (EEPROM) or a flash memory. It should be noted that the memories for the methods described in the present application are intended to include, but are not limited to, these and any other suitable types of memories.

The display screen of the computing device may be a liquid crystal display screen or an electronic ink display screen, and the input apparatus of the computing device may be a touch layer covering the display screen, or a key, a track ball or a touch pad arranged on the housing of the computing device, or an external keyboard, a touch pad or a mouse.

The computing device may be a terminal or a server. The terminal may include but not limited to: a smartphone, a tablet computer, a notebook computer, a desktop computer, a smart TV, etc.; various applications (APP) may run in the terminal, such as a multimedia playing client, a social client, a browser client, an information flow client, an education client, and the like. The server may be the server described with reference to FIG. 2, that is, it may an independent physical server, or may be a server cluster or a distributed system including a plurality of physical servers, or may be a cloud server providing basic cloud computing services such as a cloud service, a cloud database, cloud computing, a cloud function, cloud storage, a network service, cloud communication, a middleware service, a domain name service, a security service, CDN, as well as big data and an artificial intelligence platform.

According to another aspect of the present application, there is also provided a system for estimating three-dimensional key point data of objects in a target scene, including: a plurality of image acquisition devices disposed in the target scene at different positions and angles and configured to capture one or more objects in the target scene and output a plurality of images or videos which are used to obtain the plurality of images; a computing device, including: a processor, and a memory having stored thereon a computer program which, when executed by the processor, causes the processor to perform the steps of the method for estimating three-dimensional key point data of objects in the target scene as described above.

For example, the system may be as shown in FIG. 1, and the computing device may have the structure described with reference to FIG. 8.

According to another aspect of the present application, there is also provided a computer-readable storage medium storing a computer program which, when executed by a processor, causes the processor to perform the steps of the method for estimating three-dimensional key point data of objects in the target scene as described above.

According to another aspect of the present application, there is also provided a computer program product, including a computer program which, when executed by a processor, implements the steps of the method for estimating the three-dimensional key point data of objects in the target scene as described above.

It is noted that the flowcharts and block diagrams in the attached drawings illustrate possible architectures, functions and operations of the methods and apparatuses according to various embodiments of the present application. In this regard, each block in the flowcharts or the block diagrams may represent a unit, a program segment, or a part of codes, which includes at least one executable instruction for implementing a specified logical function. It is also noted that, in some alternative implementations, the functions noted in the block may occur out of the order noted in the figures. For example, two blocks shown in succession may, in fact, be executed substantially in parallel, and may sometimes be executed in the reverse order, depending on the functions involved. It is also noted that each block in the block diagrams and/or flowcharts, and combinations of blocks in the block diagrams and/or flow diagrams, may be implemented by a dedicated hardware-based system that performs specified functions or operations, or by a combination of dedicated hardware and computer instructions.

The exemplary embodiments of the present application, as set forth in the foregoing detailed description, are intended to be illustrative, not limiting. It should be understood by those skilled in the art that various modifications and combinations may be made to these embodiments or their features without departing from the principles and spirit of the present application, and such modifications should fall within the scope of the present application.

1. A method for estimating three-dimensional key point data of objects in a target scene, wherein one or more objects exist in the target scene, and the method comprises:
acquiring a plurality of images associated with the target scene, and extracting, from each image of the plurality of images, two-dimensional key point data of objects included in the image, respectively;
determining, for an image pair composed of every two images, one or more matched object pairs corresponding to the image pair based on two-dimensional key point data of each object in a first image of the image pair and two-dimensional key point data of each object in a second image of the image pair, wherein each matched object pair comprises a first object in the first image and a second object in the second image and corresponds to one object in the target scene; and
estimating three-dimensional key point data of each object in the target scene, based on the two-dimensional key point data of the first object of each matched object pair corresponding to each image pair in a respective first image and the two-dimensional key point data of the second object of the matched object pair in a respective second image.

2. The method according to claim 1, wherein the step of determining one or more matched object pairs corresponding to the image pair based on two-dimensional key point data of each object in a first image of the image pair and two-dimensional key point data of each object in a second image of the image pair comprises:
determining three-dimensional key point data of each object in the first image within a predetermined coordinate system, based on the two-dimensional key point data of each object in the first image and the two-dimensional key point data of each object in the second image;
determining re-projected two-dimensional key point data of each object in the first image within the predetermined coordinate system, based on the three-dimensional key point data of each object in the first image within the predetermined coordinate system; and
determining one or more matched object pairs corresponding to the image pair based on the re-projected two-dimensional key point data of each object in the first image within the predetermined coordinate system.

3. The method according to claim 2, wherein the step of determining three-dimensional key point data of each object in the first image within a predetermined coordinate system based on the two-dimensional key point data of each object in the first image and the two-dimensional key point data of each object in the second image comprises:
determining three-dimensional key point data of each object in the first image within a coordinate system of one of a plurality of image acquisition devices that capture the plurality of images, using a triangulation method and based on the two-dimensional key point data of each object in the first image and the two-dimensional key point data of each object in the second image;
perform coordinate transformation on the three-dimensional key point data of each object in the first image within the coordinate system of the one of the plurality of image acquisition devices, to obtain three-dimensional key point data of each object in the first image within the predetermined coordinate system.

4. The method according to claim 2, wherein the three-dimensional key point data of each object within the predetermined coordinate system is three-dimensional homogeneous coordinate data,
wherein, the step of determining the re-projected two-dimensional key point data comprises:
transforming the three-dimensional key point data of each object in the first image within the predetermined coordinate system into the three-dimensional nonhomogeneous coordinate data, to obtain re-projected two-dimensional key point data of each object in the first image within the predetermined coordinate system.

5. The method according to claim 2, wherein the step of determining one or more matched object pairs corresponding to the image pair based on the re-projected two-dimensional key point data of each object in the first image within the predetermined coordinate system comprises:
determining an error between the re-projected two-dimensional key point data of each object in the first image within the predetermined coordinate system and the two-dimensional key point data of each object in the second image within the predetermined coordinate system, as a re-projection error, based on the re-projected two-dimensional data of each object in the first image within the predetermined coordinate system; and
determining one or more matched object pairs corresponding to the image pair based on the re-projection error.

6. The method according to claim 1, wherein the step of estimating three-dimensional key point data of each object in the target scene comprises:
for each matched object pair corresponding to each image pair, determining the three-dimensional key point data, within a target coordinate system, of the object in the target scene corresponding to the matched object pair, using the triangulation method and based on the two-dimensional key point data of the first object in a respective first image and the two-dimensional key point data of the second object in a respective second image;
transforming the three-dimensional key point data, within the target coordinate system, of the object in the target scene corresponding to each matched object pair into a reference coordinate system, to obtain three-dimensional key point data, within the reference coordinate system, of the object in the target scene corresponding to each matched object pair.

7. The method according to claim 6, wherein at least two of image pairs formed by the plurality of images each comprise at least one object in the target scene,
wherein, the step of estimating three-dimensional key point data of each object in the target scene further comprises: for each object of the at least one object,
determining the three-dimensional key point data of the object within the reference coordinate system for each image pair of the at least two image pairs, respectively, to obtain at least two pieces of three-dimensional key point data corresponding to the at least two image pairs in a one-to-one manner; and
estimating final three-dimensional key point data of the object within the reference coordinate system based on the at least two pieces of three-dimensional key point data.

8. The method according to claim 7, wherein the final three-dimensional key point data of each object is a data collection of coordinate values of a plurality of key points of the object,
wherein, the method further comprises:
determining whether any two key points of each object are duplicate key points based on the final three-dimensional key point data of the object; and
performing deduplication processing in a case that it is determined that there are duplicate key points.

9. The method according to claim 1, wherein the step of extracting, from each image of the plurality of images, two-dimensional key point data of objects included in the image comprises:
performing two-dimensional key point detection on each image of the plurality of images by using a two-dimensional key point detection model, to obtain two-dimensional key point data of the objects included in the image.

10. The method according to claim 1, further comprising:
pre-calibrating rotation parameters and translation parameters between the plurality of image acquisition devices that capture the plurality of images, so that coordinate transformation is capable of being performed between a plurality of coordinate systems of the plurality of image acquisition devices.

11. A method for estimating three-dimensional key point data of objects in a target scene, wherein one or more objects exist in the target scene, and the method comprises:
acquiring a plurality of images associated with the target scene, and extracting, from each image of the plurality of images, two-dimensional key point data of objects included in the image, respectively;
based on object recognition, determining one image including a desired object from the plurality of images as a reference image;
for each image pair composed of the reference image and each remaining image in the plurality of images, determining whether the image pair corresponds to a matched object pair based on two-dimensional key point data of the desired object in the reference image as a first image of the image pair and two-dimensional key point data of each object in a second image of the image pair, wherein the matched object pair comprises the desired object in the first image and the desired object in the second image; and
estimating three-dimensional key point data of the desired object in the target scene based on the two-dimensional key point data of the desired object of each matched object pair determined for each image pair in a respective first image and the two-dimensional key point data of the desired object of the matched object pair in a respective second image.

12. An apparatus for estimating three-dimensional key point data of objects in a target scene, wherein one or more objects exist in the target scene, and the apparatus comprises:
an acquisition unit configured to acquire a plurality of images associated with the target scene, and extract, from each image of the plurality of images, two-dimensional key point data of the objects included in the image, respectively;
a determination unit configured to determine, for an image pair composed of every two images, one or more matched object pairs corresponding to the image pair based on two-dimensional key point data of each object in a first image of the image pair and two-dimensional key point data of each object in a second image of the image pair, wherein each matched object pair comprises a first object in the first image and a second object in the second image and corresponds to one object in the target scene; and
an estimation unit configured to estimate three-dimensional key point data of each object in the target scene based on the two-dimensional key point data of the first object of each matched object pair corresponding to each image pair in a respective first image and the two-dimensional key point data of the second object of the matched object pair in a respective second image.

13. The apparatus according to claim 12, wherein the determination unit comprises:
a first determination sub-unit configured to determine, for each image pair, three-dimensional key point data of each object in the first image of the image pair within a predetermined coordinate system based on the two-dimensional key point data of each object in the first image of the image pair and the two-dimensional key point data of each object in the second image;
a second determination sub-unit configured to determine, for each image pair, re-projected two-dimensional key point data of each object in the first image of the image pair within the predetermined coordinate system based on the three-dimensional key point data of each object in the first image of the image pair within the predetermined coordinate system; and
a third determination sub-unit configured to determine, for each image pair, one or more matched object pairs corresponding to the image pair based on the re-projected two-dimensional key point data of each object in the first image of the image pair within the predetermined coordinate system.

14. The apparatus according to claim 12, wherein the estimation unit comprises:
an estimation sub-unit configured to estimate, using a triangulation method and based on the two-dimensional key point data of the first object of each matched object pair corresponding to each image pair in a respective first image and the two-dimensional key point data of the second object of the matched object pair in a respective second image, three-dimensional key point data of the object in the target scene corresponding to each matched object pair within the target coordinate system;
a coordinate transformation sub-unit configured to transform the three-dimensional key point data of the object within the target coordinate system corresponding to each matched object pair into a reference coordinate system, to obtain three-dimensional key point data of the object in the target scene corresponding to each matched object pair within the reference coordinate system.

15. A computing device, comprising:
a processor, and
a memory having a computer program stored thereon, which, when executed by the processor, causes the processor to perform the method of claim 1.

16. A computer-readable storage medium having a computer program stored thereon, which, when executed by a processor, causes the processor to perform the method of claim 1.

17. A computing device, comprising:
a processor, and
a memory having a computer program stored thereon, which, when executed by the processor, causes the processor to perform the method of claim 11.

18. A computer-readable storage medium having a computer program stored thereon, which, when executed by a processor, causes the processor to perform the method of claim 11.

19. A system for estimating three-dimensional key point data of objects in a target scene, wherein one or more objects exist in the target scene, and the system comprises:
a plurality of a plurality of image acquisition devices, respectively disposed at different positions and angles for capturing images of the one or more objects; and
the apparatus for estimating the three-dimensional key point data of objects in the target scene according to claim 12.

20. The system according to claim 12, wherein, the plurality of image acquisition devices each comprises a camera.
